(19) United States
(12) Patent Application Publication
(10) Pub. No.: US 2011/0255596 A1
(43) Pub. Date: Oct. 20, 2011

(54) FRAME RATE UP CONVERSION SYSTEM AND METHOD

(75) Inventors: YING-RU CHEN, TAINAN (TW); SHENG-CHUN NIU, TAINAN (TW)

(73) Assignees: HIMAX TECHNOLOGIES LIMITED, TAINAN (TW); HIMAX MEDIA SOLUTIONS, INC., TAINAN (TW)

(21) Appl. No.: 12/761,304

(22) Filed: Apr. 15, 2010

(51) Int. Cl. H04N 7/26

(52) U.S. Cl. 375/240.16; 375/E07.125

(57) ABSTRACT

The invention is directed to a frame rate up conversion (FRUC) system and method. A motion estimation (ME) unit is configured to generate at least one motion vector (MV) according to a frame input. A triple-line buffer based motion compensation (MC) unit is configured to generate an interpolated frame according to the MV, a reference frame and a current frame, thereby generating a frame output with a frame rate higher than a frame rate of the frame input.

### BACKGROUND OF THE INVENTION

1. Field of the Invention

The present invention generally relates to frame rate up conversion, and more particularly to spatial interpolation and smoothing on an interpolated frame.

2. Description of Related Art

Frame rate up conversion (FRUC) is commonly used in a digital image display such as digital TV to generate one or more interpolated frames between two original adjacent frames, such that the display frame rate may be increased, for example, from 60 Hz to 120 Hz or 240 Hz. The generation of the interpolated frame is typically performed by using interpolation of motion compensation technique. It is shown in FIG. 1 that a block-based motion estimation/compensation is usually adopted in generating an interpolated frame according to a previous frame A and a current frame B. Specifically, the motion of a macroblock (MB) in the current frame B with respect to the corresponding MB in the previous frame A is firstly estimated. The interpolated frame is then interpolated based on the motion estimation.

Disrupted areas (or gaps), in which no motion vector is generated, usually occur in the interpolated frame for the block-based motion compensation. Further, side effect usually exists along the boundary between adjacent blocks for the block-based motion compensation. In order to overcome the disrupted areas problem, conventional system or method uses line-buffers to store the pixels of the current block and some pixels of the previous block and the next block. For example, with respect to an 8×8 block-based system or method, ten line-buffers are required to store eight lines of the current block, the last line of the previous block, and the first line of the next block. Accessing the pixels of the ten line-buffers demands substantial time and thus makes the real-time image display inconceivable. Moreover, the ten line-buffers disadvantageously increase circuit area and the cost.

For the reason that conventional system or method cannot effectively solve the disrupted areas problem and the side effect, a need has arisen to propose a novel system and method for effectively and economically generating an interpolated frame without disrupted areas and side effect.

### SUMMARY OF THE INVENTION

In view of the foregoing, it is an object of the embodiment of the present invention to provide a frame rate up conversion (FRUC) system and method for mending and smoothing a generated interpolated frame with reduced buffer resource.

According to one embodiment, the frame rate up conversion (FRUC) system includes a motion estimation (ME) unit and a triple-line buffer based motion compensation (MC) unit. The ME unit generates at least one motion vector (MV) according to a sequential frame input. The MC unit generates an interpolated frame according to the MV, a reference frame and a current frame, thereby generating a sequential frame output with a frame rate higher than a frame rate of the frame input.

### BRIEF DESCRIPTION OF THE DRAWINGS

FIG. 1 shows an example of generating an interpolated frame according to a previous frame and a current frame;

FIG. 2A shows a block diagram that illustrates a frame rate up conversion (FRUC) system according to one embodiment of the present invention;

FIG. 2B shows a flow diagram that illustrates a frame rate up conversion (FRUC) method according to one embodiment of the present invention;

FIG. 3A shows a detailed block diagram of the motion compensation (MC) unit of FIG. 2A according to one embodiment of the present invention;

FIG. 3B shows a detailed flow diagram of the step of generating the interpolated frame of FIG. 2B according to one embodiment of the present invention;

FIG. 4A shows a detailed block diagram of the spatial interpolation unit of FIG. 3A according to one embodiment of the present invention;

FIG. 4B shows a detailed flow diagram of the step of mending the disrupted areas by spatial interpolation of FIG. 3B according to one embodiment of the present invention;

FIG. 5A and FIG. 5B show exemplary cases in which the last line of the previous block, the current line, and the first line of the next block are stored in the triple-line buffer;

FIG. 6 shows an exemplary embodiment of performing spatial interpolation by the spatial interpolation processor; and

FIG. 7 shows an exemplary embodiment of performing smoothing.

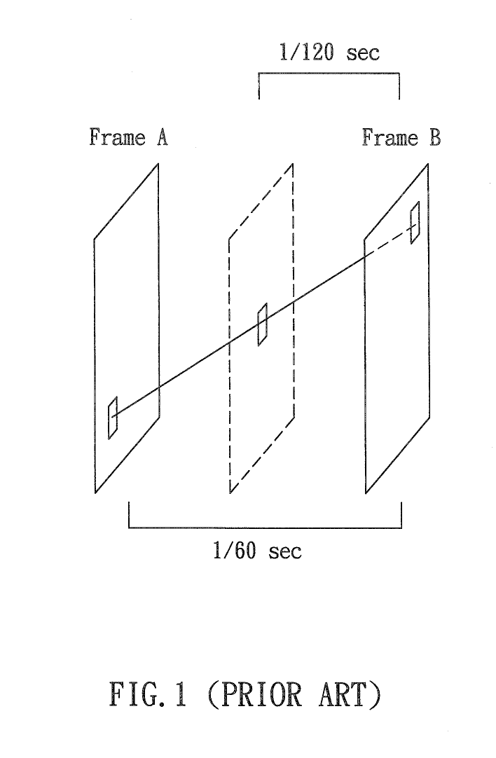

### DETAILED DESCRIPTION OF THE INVENTION

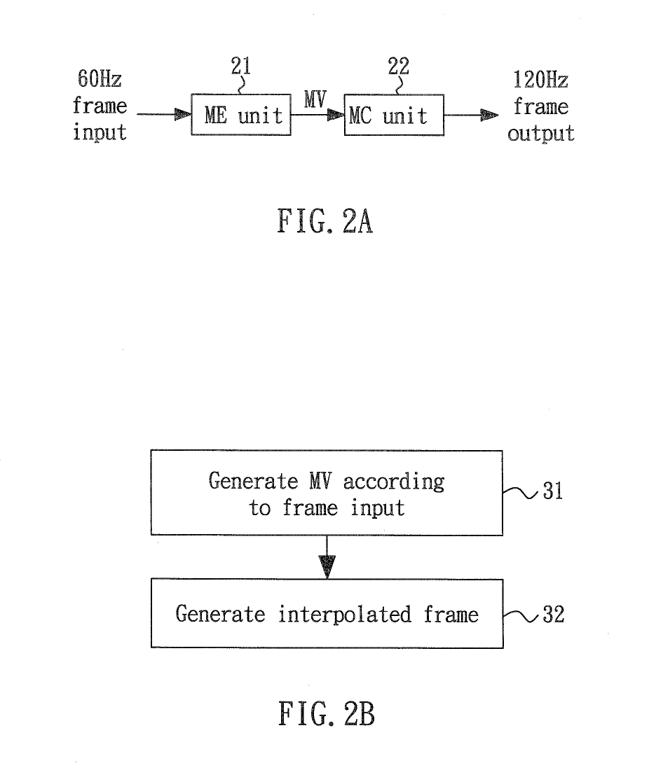

FIG. 2A shows a block diagram that illustrates a frame rate up conversion (FRUC) system according to one embodiment of the present invention. FIG. 2B shows a flow diagram that illustrates a frame rate up conversion (FRUC) method according to one embodiment of the present invention. The FRUC system primarily includes a motion estimation (ME) unit 21 and a motion compensation (MC) unit 22. In step 31, the ME unit 21 receives a sequential frame input with an original frame rate, for example, of 60 Hz, and accordingly generates a motion vector (MV) or a MV map. In step 32, the MC unit 22, particularly a triple-line buffer based MC unit, then generates an interpolated frame according to the MV/MV map, a reference frame (e.g., a preceding frame or a succeeding frame) and a current frame, therefore generating a sequential frame output with an increased frame rate, for example, of 120 Hz. In the embodiment, a block-based motion compensation is adopted.

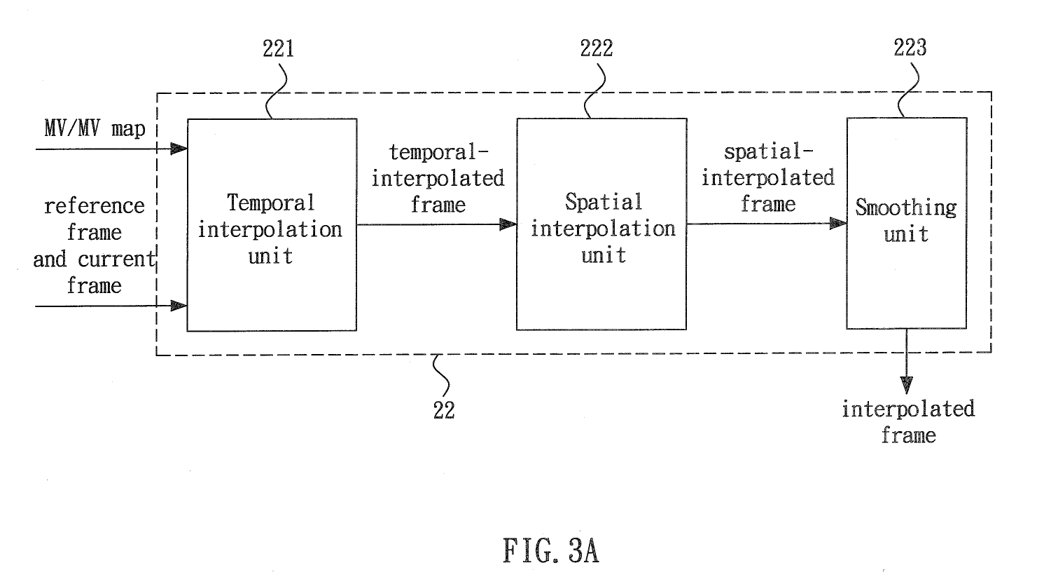

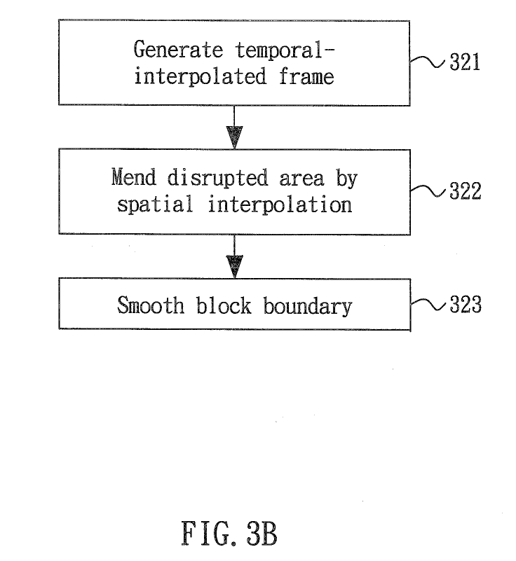

FIG. 3A shows a detailed block diagram of the motion compensation (MC) unit 22 of FIG. 2A according to one embodiment of the present invention. FIG. 3B shows a detailed flow diagram of the step of generating the interpolated frame (step 32) of FIG. 2B according to one embodiment of the present invention. In the embodiment, the MC unit 22 includes a temporal interpolation unit 221, a spatial interpolation unit 222 and a smoothing unit 223. The temporal interpolation unit 221, in step 321, generates a temporal-interpolated frame according to the MV/MV map, the reference frame and the current frame (the reference frame and the current frame may be obtained from the ME unit 21 or access from a frame stored memory). As disrupted areas (or gaps) usually occur in the temporal-interpolated frame for the block-based motion compensation, the spatial interpolation unit 222 is utilized to perform spatial interpolation on the temporal-interpolated frame in order to mend the disrupted areas in step 322. The mending of the disrupted areas will be discussed in details later in this specification. Moreover, as side effect usually exists along the boundary between the blocks for the block-based motion compensation, the smoothing unit 23 is further utilized to perform smoothing on the spatial-interpolated frame along the boundary between the blocks in order to alleviate the side effect in step 323. The smoothing of the block boundary will be discussed in details later in this specification.

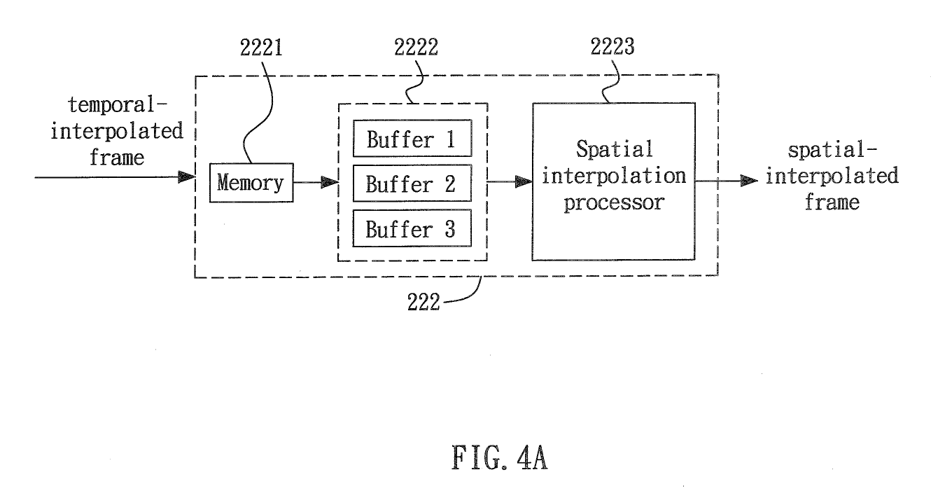

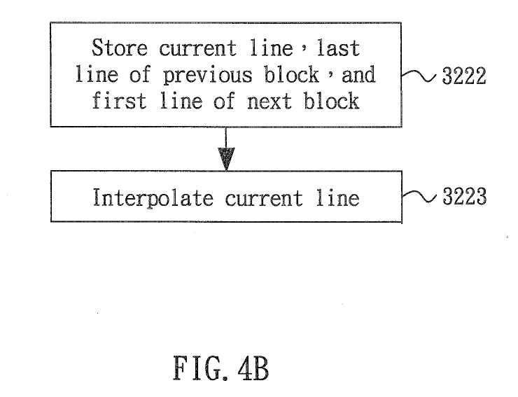

FIG. 4A shows a detailed block diagram of the spatial interpolation unit 222 of FIG. 3A according to one embodiment of the present invention. FIG. 4B shows a detailed flow diagram of the step of mending the disrupted areas by spatial interpolation (step 322) of FIG. 3B according to one embodiment of the present invention. In the embodiment, the spatial interpolation unit 222 includes a memory 2221, a triple-line buffer 2222 and a spatial interpolation processor 2223. The memory 2221 provides a number of lines of pixel blocks. The triple-line buffer 2222 includes three line-buffers that are used to respectively store a current line to be processed, the last line of a previous block, and the first line of a next block (step 3222). The current line is then subjected to spatial interpolation, by the spatial interpolation processor 2223, according to the stored last line of the previous (upper adjacent) block and the stored first line of the next (lower adjacent) block (step 3223). As only three line-buffers are used in the embodiment in performing spatial interpolation (and smoothing), the present embodiment may substantially reduce hardware resource and speed up the interpolation (and smoothing) compared to the conventional system and method.

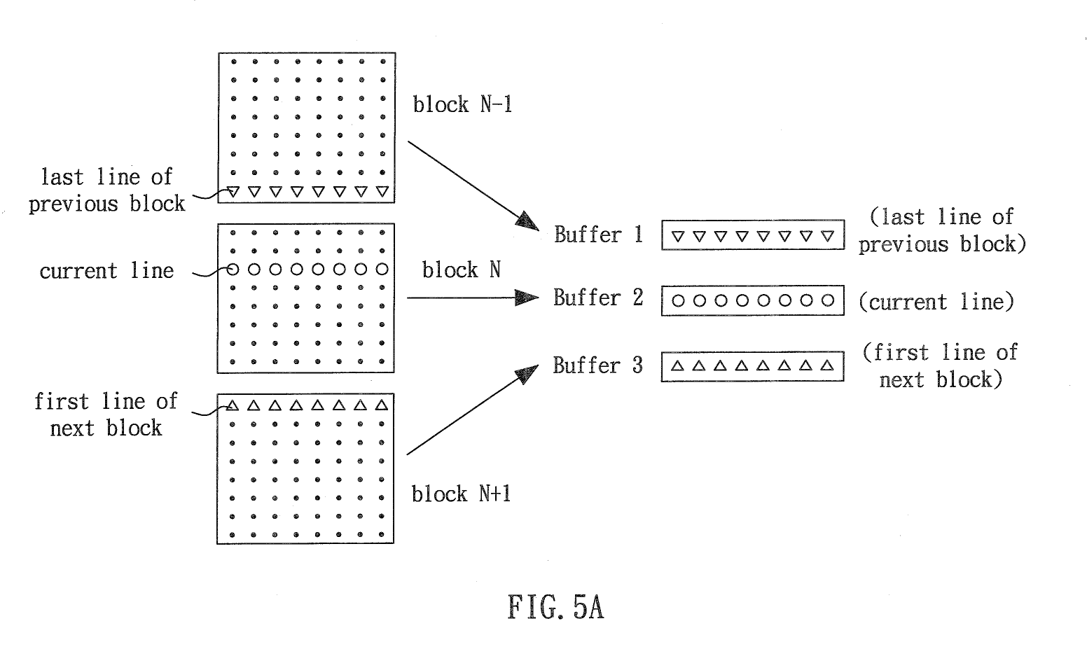

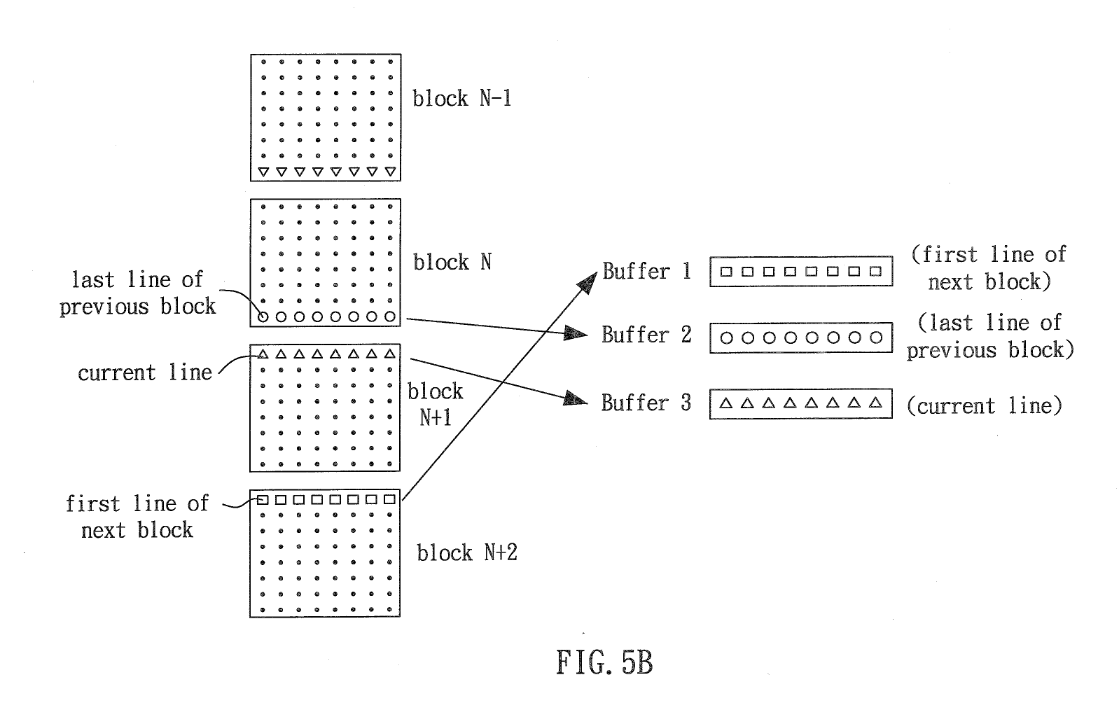

FIG. 5A shows an exemplary case during which the last line of the previous block N−1 is stored in the buffer 1, the current line of the current block N is stored in the buffer 2, and the first line of the next block N+1 is stored in the buffer 3, where the block N−1, the block N and the block N+1 are sequential blocks in vertical direction of an image. For the subsequent lines of the same block N, the buffer 2 is over-written by the succeeding current line each time. As shown in another exemplary case in FIG. 5B, after finishing processing the last line of the block N, the first line of the block N+1 becomes the current line. As this line has been stored beforehand in the buffer 3, no need is required to retrieve this line from the memory 2221 again. Further, the finished last line of the block N remained in the buffer 2 now becomes the last line of the previous block N. At the same time, the first line of the block N+2 is retrieved from the memory 2221 and is stored in the buffer 1. For the subsequent lines of the same block N+1, the buffer 3 (rather than the buffer 2 as in the case shown in FIG. 5A) is over-written by the succeeding current line each time. The cases exemplified in FIG. 5A and FIG. 5B may be accordingly reiterated for all blocks.

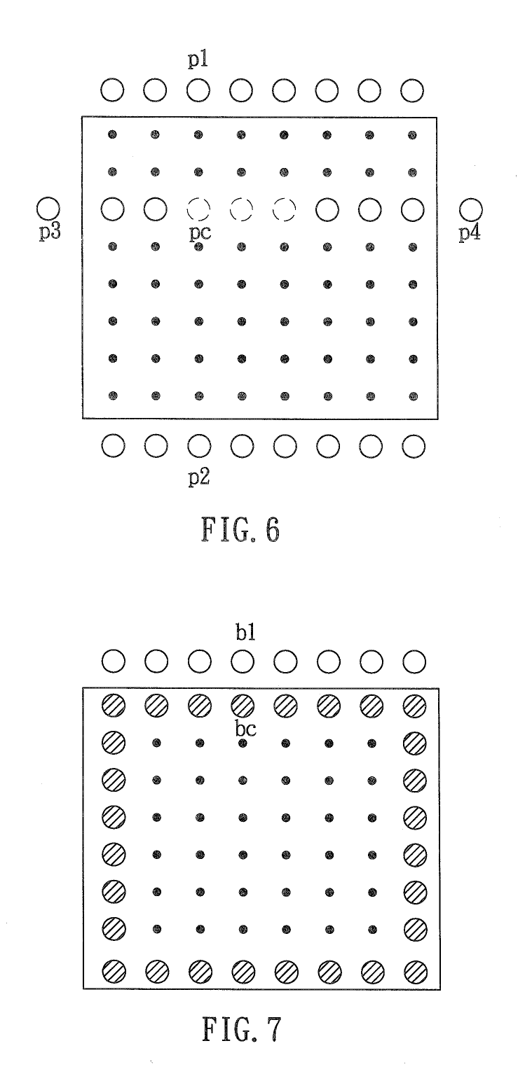

FIG. 6 shows an exemplary embodiment of performing spatial interpolation (step 3222) by the spatial interpolation processor 2223. In one exemplary embodiment, a pixel pc of a current line is spatial-interpolated according to the pixel p1 of the last line of the previous block and the pixel p2 of the first line of the next block. For example, the value of the pixel pc may be calculated as follows:

pc=[p1*n1+p2*n2]/(n1+n2)

where n1 and n2 are weightings for the pixel p1 and p2 respectively.

In another exemplary embodiment, the pixel pc of the current line is spatial-interpolated according to four pixels: the pixel p1 of the last line of the previous block, the pixel p2 of the first line of the next block, a pixel p3 of a left-side adjacent block, and a pixel p4 of a right-side adjacent block.

Subsequently, the spatial-interpolated frame may be subjected to smoothing operation (step 323) by the smoothing unit 223. In the embodiment, a low-pass filtering (LPF) is adopted to smooth the block boundary to alleviate the side effect. FIG. 7 shows an exemplary embodiment of performing smoothing. In the exemplary embodiment, a pixel bc of a current line is smoothed according to itself (i.e., the pixel bc) and a pixel b1 of the last line of a previous block. For example, the value of the smoothed pixel bc′ may be calculated as follows:

bc′=[b1*n1+bc*n2]/(n1+n2).

where n1 and n2 are weightings for the pixel b1 and bc respectively.

Although specific embodiments have been illustrated and described, it will be appreciated by those skilled in the art that various modifications may be made without departing from the scope of the present invention, which is intended to be limited solely by the appended claims.

What is claimed is:

1. A frame rate up conversion (FRUC) system, comprising:
a motion estimation (ME) unit configured to generate at least one motion vector (MV) according to a sequential frame input; and
a triple-line buffer based motion compensation (MC) unit configured to generate an interpolated frame according to the MV, a reference frame and a current frame, thereby generating a frame output with a frame rate higher than a frame rate of the frame input.

2. The system of claim 1, wherein the reference frame is a preceding frame.

3. The system of claim 1, wherein the MC unit comprises:
a temporal interpolation unit configured to generate a temporal-interpolated frame according to the MV, the reference frame and the current frame; and
a spatial interpolation unit configured to perform spatial interpolation on the temporal-interpolated frame, thereby generating a spatial-interpolated frame.

4. The system of claim 3, further comprising a smoothing unit configured to perform smoothing on the spatial-interpolated frame along a boundary between adjacent blocks.

5. The system of claim 4, wherein the smoothing is a low-pass filtering.

6. The system of claim 3, wherein the spatial interpolation unit comprises:
a memory that provides a plurality of lines of pixel blocks;
a triple-line buffer including three line-buffers configured to store a current line, a last line of a previous block, and a first line of a next block respectively; and
a spatial interpolation processor configured to perform spatial interpolation on the current line according to the stored last line of the previous block and the stored first line of the next block.

7. The system of claim 6, wherein the line buffer that stores the current line is over-written by a succeeding current line.

8. The system of claim 6, during a first period, wherein the three line buffers includes:
a first buffer configured to store the last line of the previous block N−1;
a second buffer configured to store the current line of the current block N; and
a third buffer configured to store the first line of the next block N+1;
wherein the block N−1, the block N and the block N+1 are sequential blocks in vertical direction of an image.

9. The system of claim 8, during a second period, the first buffer is configured to store the first line of a block N+2, the second buffer is configured to store the last line of the block N, and the third buffer is configured to store the current line of the block N+1, wherein the block N, the block N+1 and the block N+2 are sequential blocks in vertical direction of the image.

10. The system of claim 6, wherein a pixel of the current line to be processed is spatial-interpolated according to a pixel of the last line of the previous block and a pixel of the first line of the next block.

11. A frame rate up conversion (FRUC) method, comprising:
performing motion estimation (ME) to generate at least one motion vector (MV) according to a sequential frame input; and
performing a triple-line buffer based motion compensation (MC) to generate an interpolated frame according to the MV, a reference frame and a current frame, thereby generating a frame output with a frame rate higher than a frame rate of the frame input.

12. The method of claim 11, wherein the reference frame is a preceding frame.

13. The method of claim 11, wherein the MC step comprises:
performing temporal interpolation to generate a temporal-interpolated frame according to the MV, the reference frame and the current frame; and
performing spatial interpolation on the temporal-interpolated frame, thereby generating a spatial-interpolated frame.

14. The method of claim 13, further comprising a step of performing smoothing on the spatial-interpolated frame along a boundary between adjacent blocks.

15. The method of claim 14, wherein the smoothing is a low-pass filtering.

16. The method of claim 13, wherein the spatial interpolation step comprises:
providing a plurality of lines of pixel blocks;
storing a current line, a last line of a previous block, and a first line of a next block respectively in three line-buffers respectively; and
performing spatial interpolation on the current line according to the stored last line of the previous block and the stored first line of the next block.

17. The method of claim 16, further comprising a step of over-writing the line buffer that stores the current line by a succeeding current line.

18. The method of claim 16, during a first period, wherein the line-buffers storing step includes:
storing the last line of the previous block N−1 in a first buffer;
storing the current line of the current block N in a second buffer; and
storing the first line of the next block N+1 in a third buffer;
wherein the block N−1, the block N and the block N+1 are sequential blocks in vertical direction of an image.

19. The method of claim 18, during a second period, wherein the line-buffers storing step includes:
storing the first line of a block N+2 in the first buffer;
storing the last line of the block N in the second buffer; and
storing the current line of the block N+1 in the third buffer;
wherein the block N, the block N+1 and the block N+2 are sequential blocks in vertical direction of the image.

20. The method of claim 16, wherein the spatial interpolation step comprises:
spatial-interpolating a pixel of the current line to be processed according to a pixel of the last line of the previous block and a pixel of the first line of the next block.
